(19) United States
(12) Patent Application Publication
(10) Pub. No.: US 2020/0380440 A1
(43) Pub. Date: Dec. 3, 2020

(54) Optimizing Cloud Services based on Resource Usage Analysis

(71) Applicant: Prashant Shyamsundar Mishra, Redmond, WA (US)

(72) Inventor: Prashant Shyamsundar Mishra, Redmond, WA (US)

(21) Appl. No.: 16/423,166

(22) Filed: May 28, 2019

(51) Int. Cl. G06Q 10/06; G06Q 10/10; G06Q 10/04; G06Q 20/12; G06N 5/04

(52) U.S. Cl. CPC G06Q 10/06315; G06Q 10/109; G06N 5/04; G06Q 20/127; G06Q 10/04

(57) ABSTRACT

The current invention will be used for optimizing the usage of resources by analysing the past usage pattern of the resources purchased from a cloud provider. This tool will give recommendation for manually reallocating or resizing of resources or based on the intelligence built-in the toll it will automatically allocate and resize resources based on analysis of the usage pattern. By using this tool client can reduce on cost as they can free out the unused resources which will result in reduction of cloud billing. The client can also use this tool to study their usage pattern over time. The recommendations provided by the tool will help the clients in doing proper forecasting so that he saves on the cost and effort required for using the cloud. The client can also use the software to remove potential inefficiencies by analysing the reports generated. The tool can be used to set the minimum and maximum usage threshold of the resources so that they can get notifications and reminders if those thresholds are being breached regularly. This helps the client in optimising the use of his resources and do proper forecasting so that he saves on cost and effort in maintaining his usage of Cloud.

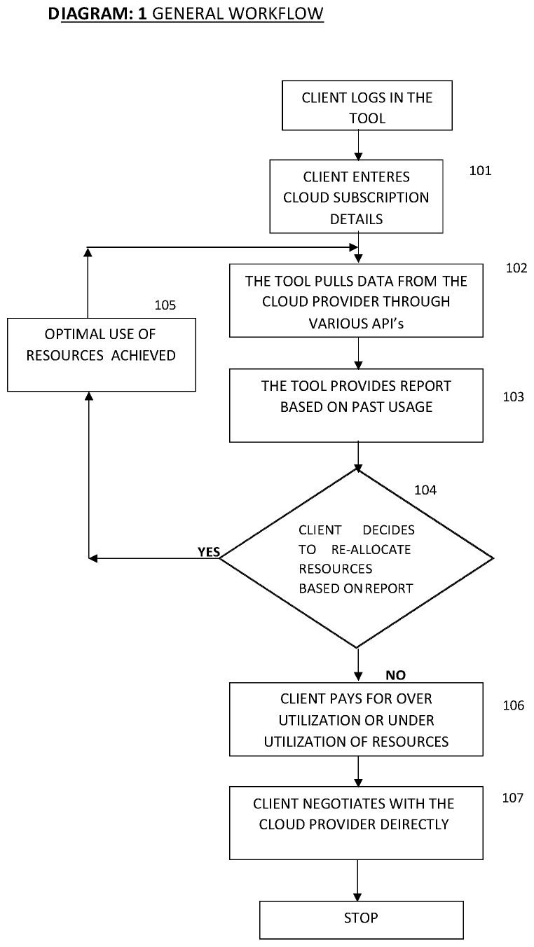

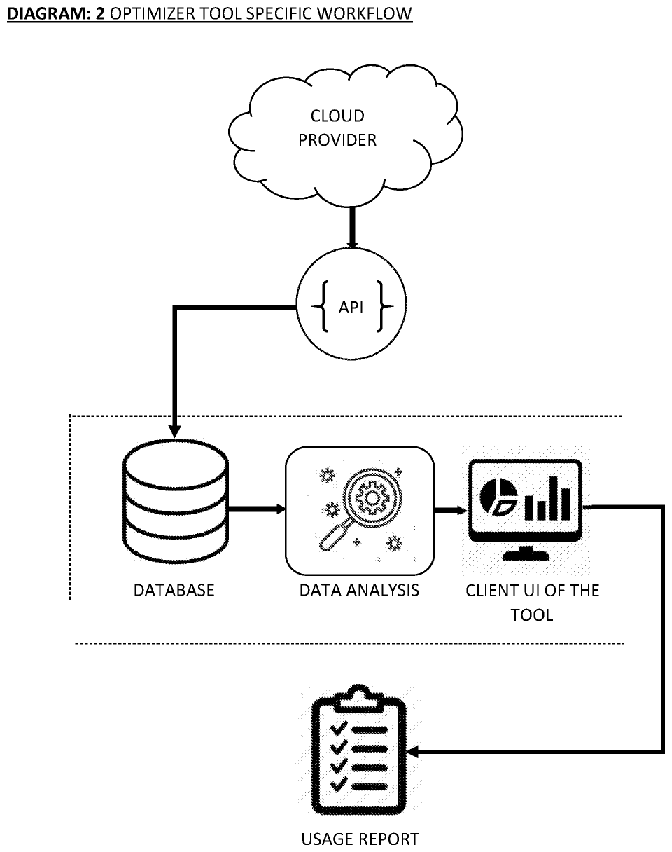

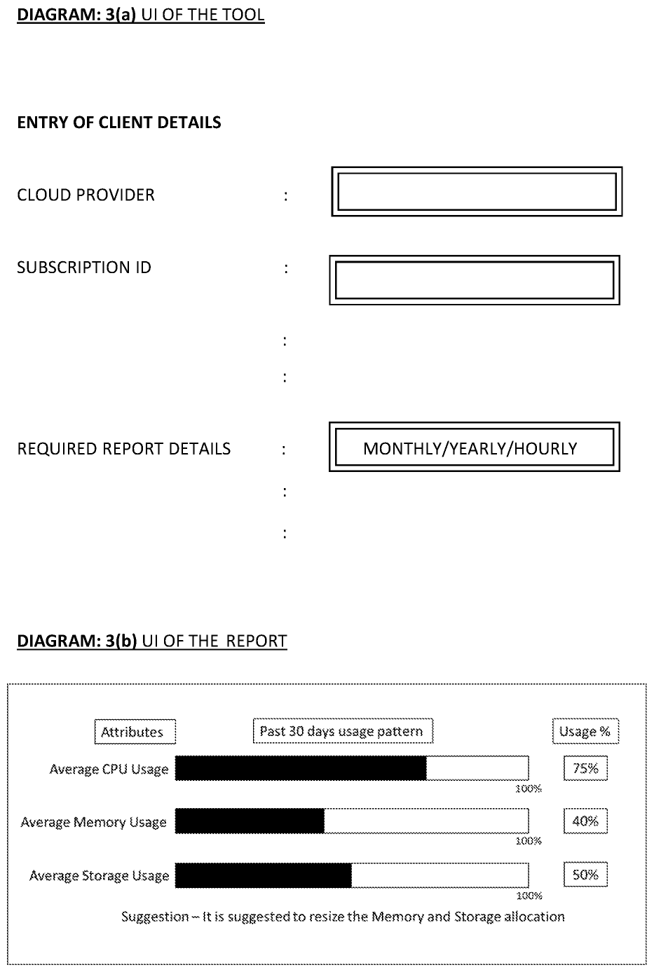

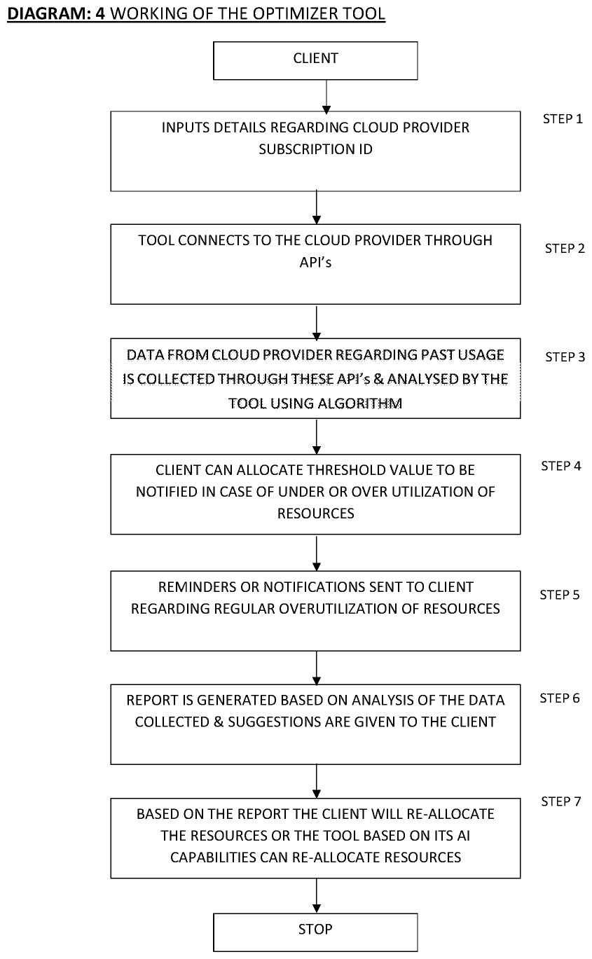

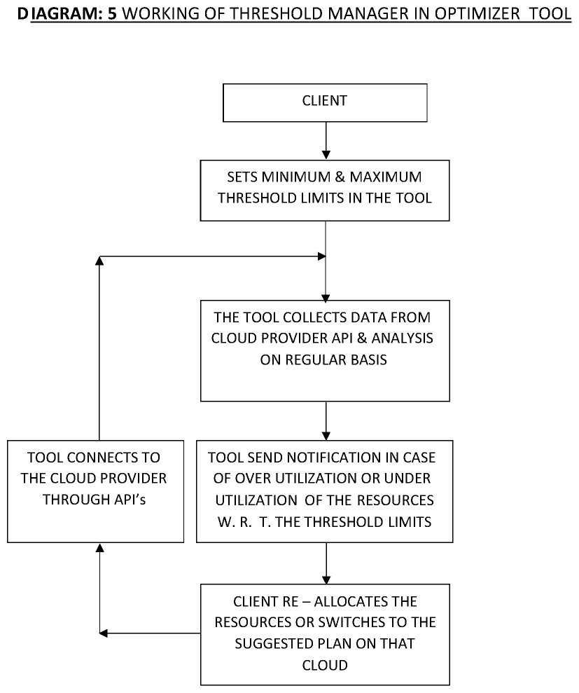

For Example

If the client is constantly underusing the resources like memory or compute then the tool will give recommendation to client to resize the resources accordingly. With the help of in built AI technology, The tool can also automatically allocate resources according to the usage pattern. This will help the client in achieving maximum efficiency either by saving cloud cost or can free resources on cloud for other use.

### TECHNICAL FIELD

The present invention relates generally to data processing system, more particularly, comparing the usage of resources on cloud against resources purchased as well as setting threshold for minimum and maximum usage of resources.

### BACKGROUND OF THE INVENTION

Clients generally purchase resources on cloud and the cloud providers bill them based on consumption of these resources. The billing can be divided into fixed cost and Pay as you go. If the client decides to go ahead with Fixed cost billing he would require to optimally forecast the required resource while in Pay as you go the client can allocate resources on the go and he will be billed at the end of the month or year. However, in both types of billing customer needs to manually keep track of the resources being used and constantly allocate and reallocate resources as per the requirement manually. In due course of time there will be issues in keeping track of the resources and billing as someone must get usage reports from the cloud providers manually and analyse them to take a decision. This results in delay to implement corrective steps which results in unnecessary expenditure on cloud due to over utilisation or underutilisation of resources.

For Example—If the client has purchased 100 TB of storage and the usage is only 60% to 70% then the client must manually reduce the storage. In this process, the client losses money till he resizes the storage. Same thing happens with CPU usage where customer can end up buying more than required and till he resizes the client ends up paying more. Similarly, in Pay-as-you-go model due to unavailability of forecasting report the client ends up paying more.

### SUMMARY OF THE INVENTION

It is, therefore, object of this software to provide proper forecasting. This software will help the client to optimize their resources purchased on the cloud based on the forecasting reports generated. The Client UI will have the option to input the subscription details taken from the cloud provider. The software will get the usage details and the required data from the cloud provider and generate a report. The client will have an option of manually configuring the threshold value or choose to allow the software to automatically adjust the values based on the past usage. The software can be used to manage multiple subscriptions similarly. The client also has an option to switch between automatic and manual mode.

There will be a provision of getting reminders from the software where ever the resources are being overutilized or underutilized so that the client can make the necessary changes manually or predefine actions to be taken automatically.

For Example—If the client has taken a 100 TB of storage and inputs the subscription details in the software then it will pull all the required data and monitor the usage of the resource. The client will have an option to set the minimum usage and the maximum usage threshold. Whenever the Threshold is being crossed the client will get a reminder via email and he will have an option to act on real time basis. The user can also have some predefined actionable defined if he finds similar behaviour on regular basis.

Below is the illustration on how the tool will give the results:

The tool will analyse the usage pattern of the specific resource taken by the cloud provider and provide report and suggestion to either resize or reallocate the resources.
If the usage of the resource is only 50% to 60% then the tool will suggest resizing the resource to 70% there by saving the cost
If the usage is below 50% then the tool will suggest resizing the resource to 50%
The user can also set thresholds using this tool so that if the usage goes beyond the set threshold then the client can purchase extra resource rather than paying in the pay-as-you-go model which will be costlier.

The optimizer tool records the Maximum and Minimum usage and analyses the database collected to give feedback using the following pseudocodes. Developers may choose any number of languages to run Optimiser software with, so pseudocodes are necessary. These pseudocodes CASE constructs are meant to be easily understood by any developer and then converted into a computer language of any choice for implantation.

A. Scenario where the user purchases a resource on Cloud and the resource is being underutilized constantly then notifications are sent to client based on below mentioned algorithm.
If resource usage is ≤70% every time the cloud is used then, resize the resource to 75% of the currently purchase.
If resource usage is ≤40% every time the cloud is used then, resize the resource to 50% of the currently purchase.
If resource usage is ≤20% every time the cloud is used then, resize the resource to 25% of the currently purchase.
If resource usage falls below 10% then the user gets a notification to reconsider purchasing that resource on cloud.

B. Scenario where the user purchases a resource on Cloud and it is being over utilised constantly then notifications are sent to client based on below mentioned algorithm.
If resource usage is ≥120% every time the cloud is used then, resizing the resource by purchasing additional 25% to the current purchase.
If resource usage is ≥140% every time the cloud is used then, resizing the resource by purchasing additional 50% to the current purchase.
If resource usage is ≥170% every time the cloud is used then, resizing the resource by purchasing additional 75% to the current purchase.
If resource usage grows beyond 190% then the user gets a notification to reconsider the current purchase and go for the next higher-level plan

This needs to be part of the tool because if the user keeps paying in Pay-As-You-Go model to the cloud provider then the cost incurred will be higher than what the user will incur if he does proper resource planning of his company resource in cloud.

C. The tool will also have a feature where the user can define a safe range of operation for the cloud resource and if the usage parameters go below or above the predefined threshold levels there will be appropriate notifications sent to the client.
If the resource usage is between 25% to 100% every time the cloud is used then, there will no notification sent to the user.
If the resource usage is between 10% to 25% every time the cloud is used then, the user will be notified to resize the resource to 25% of the current purchase.
If the resource usage goes below 10% every time the cloud is used then, the user will be notified to revaluate the current purchase plan.
If the resource usage goes above 100% every time the cloud is used then, the user will get notification to either purchase additional resource to the current purchase or revaluate the current purchase plan.

The tool will also be able to compare between resources in different geographies and intimate the client about the same resource being available at a cheaper rate at different location. The user can then make necessary changes and allocate a different location for the resource there by resulting in saving client's expenditure on cloud. The tool will also have an inbuilt intelligence of detecting the best suited offer depending on the proximity of the available cloud infrastructure from the user location

For Example—If the user has purchased 100 TB of storage at location A at a certain price and the same amount of storage is available at location B at 30% lesser cost then the tool will intimate the client about the best offer available with the details about the location it is available at with the percentage saving that would be achieved by the client if he moves from location A to location B.

### BRIEF DESCRIPTION OF THE DRAWINGS

Diagram 1: is a general workflow of a routine followed by the client to use the tool.

Diagram 2: Pictorial representation of the workflow for generating reports ready to be consumed by the client.

Diagram 3(a): illustrate a data entry form and the custom report generation form

Diagram 3(b): Illustrates the way the usage report will be displayed with suggestion from the software.

Diagram 4: illustrates step by step algorithm behind the current invention.

Diagram 5: is a block diagram illustrating the algorithm behind the threshold manager which is part of current invention.

### DETAILED DESCRIPTION OF THE INVENTION

The present invention provides a method where the client can optimize his usage of resources purchased on the cloud. This invention is intended towards saving clients effort and cost spent due to underutilised or overutilization of resources. The reporting feature of the tool helps in providing real time usage reports to the client so that they can reallocate or resize the resources depending on the usage pattern. The data is collected by the software through the API's provided by the cloud providers. The reallocation or resizing of the resources based on this reporting system helps client to reduce their expense on cloud because of underutilisation of the purchased resources. The threshold management feature in the tool helps in pre-setting a Maximum and Minimum usage limit. Whenever the client usage reaches this threshold he gets a notification via email regarding the issue and recommended steps to achieve optimum utilization of resources. This will happen on real time basis and the allocation and reallocation of resources will happen dynamically.

Diagram 1: is a general workflow of a routine followed by the client to use the tool.

Client can start using the tool by entering the details about the cloud provider and the subscription details. Using these details, the software will pull data regarding the resources purchased by the client using API's provided by the cloud providers. The tool will then analyse the data and provide a report to the user showing the current usage pattern and comparing it with the resources purchased. Using these reports customer can understand weather they are underutilising or overutilizing the resources, under both circumstances client will end up paying more. With the help of the reports generated by the software the client can take decisions on reallocation or resizing the resources so that they can saves on cost and effort.

Diagram 2: Pictorial representation of the workflow for generating reports ready to be consumed by the client. This workflow illustrates the tool interaction with the cloud provider through their API's to collect the usage data. This data is then analysed to provide statistics in the form of dashboard to the clients. The client can generate usage report through this tool and get recommendation on resizing or reallocation of resources. Based on these resources client can act on the recommendations provided by the tool and save on cost and effort. Since this happens on real time basis the client can make decisions immediately so that the billing of the resources changes immediately.

Diagram 3(a): Illustrate a data entry form and the custom report generation form. When collecting information from a user, a Web page typically consists of a long series of data entry fields that may not all fit onto the display at the same time. Thus, a user needs to scroll through the Web page to enter the information. When the data entry fields do not fit onto the display at the same time, it is difficult for the user to get an overall understanding of the type and organization of the data to be entered. The hierarchical data entry mechanism allows a user to understand the overall organization of the data to be entered even though the all data entry fields would not fit onto the display at the same time. The diagram illustrates an outline format of a sample form to be filled in.

Diagram 3(b): Illustrates the way the usage report will be displayed with suggestion from the software.

The Report generated by the software will have the average usage of the attributes over the past 30 days. This will be shown in graphical representation as well as in percentage. The report will also have suggestions for the users to either maintain the as is status or resize the allocation based on the study of the resources.

Diagram 4: illustrates step by step algorithm behind the current invention.

Step 1-7 illustrates how the tool can help client reduce their cost and effort by reallocation and resizing of the resources by analysing the past usage data. In Step 1, the client will input the details about the cloud provider and the subscription taken for that cloud provider, the page may ask for some more details. Step 2, based on the inputs provided by client the tool will get the usage data from the cloud providers using their API's. Step 3, the usage data collected by the tool from the cloud providers will be analysed by the tool and the recommendation will be provided to the clients.

The software is also capable to provide consolidated reports for the clients to analyse and take decision accordingly regarding resizing or reallocation of resources. Step 4, the client can also set pre-defined parameters regarding usage of resources. Step 5, Customise notifications can be sent to the clients regarding underutilisation or overutilization of resources. Step 6, The tool will generate reports on regular basis by analysing the data and recommendations would be given to the clients for resizing or reallocation of resources. Step 7, The client can use the recommendation and resize their resources so that he can achieve optimization of his resources with regards to cost.

Diagram 5: is a block diagram illustrating the algorithm behind the threshold manager which is part of current invention. The client uses this feature of the tool to fix a maximum and minimum usage threshold limits of the resources. The usage data collected by the tool from the cloud providers is analysed on regular basis and notifications or reminders are sent to client is the usage falls below the minimum usage limit or goes above the maximum usage limit regularly. Based on the usage reports and recommendation given by the tool the client can take a decision to reallocate or resize the resource. Once the resources are reallocated the client will again reset the maximum and minimum usage thresholds.

Although the present invention has been described in terms of various embodiments, it is not intended that the invention be limited to these embodiments. Modification within the spirit of the invention will be apparent to those skilled in the art.

We claim:

1. The Method of comparing the current usage verses the resources purchased.

2. Recommendation algorithm to optimise the usage of the resources based on Method of claim 1.

3. Reports generated using method of claim 1

4. The method of setting minimum and maximum threshold and sending reminders.
